(19) United States
(12) Patent Application Publication
(10) Pub. No.: US 2012/0089849 A1
(43) Pub. Date: Apr. 12, 2012

(54) COOKIE MANAGEMENT SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/175,100

(22) Filed: Jul. 1, 2011

(30) Foreign Application Priority Data
Oct. 7, 2010 (TW) 99134135

(51) Int. Cl. G06F 12/14

(52) U.S. Cl. 713/189

(57) ABSTRACT

A system for managing cookies in a client device on a network includes a communication module, a cookie parser, an encryption module, and a storing module. The communication module sends an HTTP request to a web server on the network, and the cookie parser extracts any cookie data from the HTTP response by the web server. The encryption module encrypts the cookie data and the storing module stores the encrypted data in a memory area of the client device.

### BACKGROUND

1. Technical Field

The disclosure generally relates to a system and method for managing cookies in a client device on a network.

2. Description of Related Art

Many web sites attempt to store information on a user's computer in a small file referred to as a cookie. Cookies provide for HTTP state management, by which a server may correlate multiple requests from the same client. Cookies may include sensitive and personal information, or contain keys needed to access a user's sensitive and personal information. However, there is a common security problem that user's information may be easily divulged since cookies are conventionally stored in a local hard drive which may possibly be accessed by the network. Therefore, there is room for improvement in cookie management.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a cookie management system installed in a client device.

FIG. 2 is a schematic diagram of one embodiment of the function modules of the cookie management system of FIG. 1.

FIG. 3 is an operational flow diagram representing an exemplary embodiment for a cookie-receiving process for cookies from a web server using the cookie management system of FIG. 1.

FIG. 4 is an operational flow diagram representing an exemplary embodiment for packing cookies using the cookie management system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

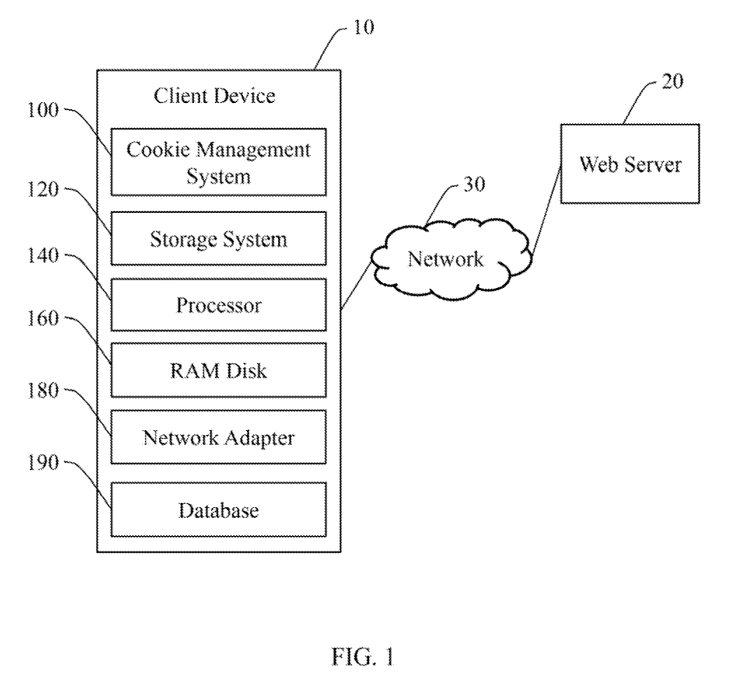

FIG. 1 is a schematic diagram of one embodiment of a client device 10. In the embodiment, the client device 10 may include a cookie management system 100, a storage system 120, at least one processor 140, a RAM disk 160, a network adapter 180 and a database 190. The functions of the cookie management system 100 are implemented by the client device 10. The cookie management system 100 may communicate with a web server 20 via a network 30 and manage a plurality of cookies associated with at least one web server 20. The client device 10 may be a desktop computer, a flat panel computer, a PDA or a smart phone.

In one embodiment, the storage system 120 may be a magnetic or an optical storage system, such as a hard disk drive, an optical drive, or a tape drive. The RAM disk 160 is a step of RAM that is treated as a disk drive available for memory by software in a computer. The network adapter 180 may be a network interface card using a specific physical layer and data link layer standard such as Ethernet or Wi-Fi. The network 30 may be a local area network (LAN) or a wide area network (WAN), such as the Internet.

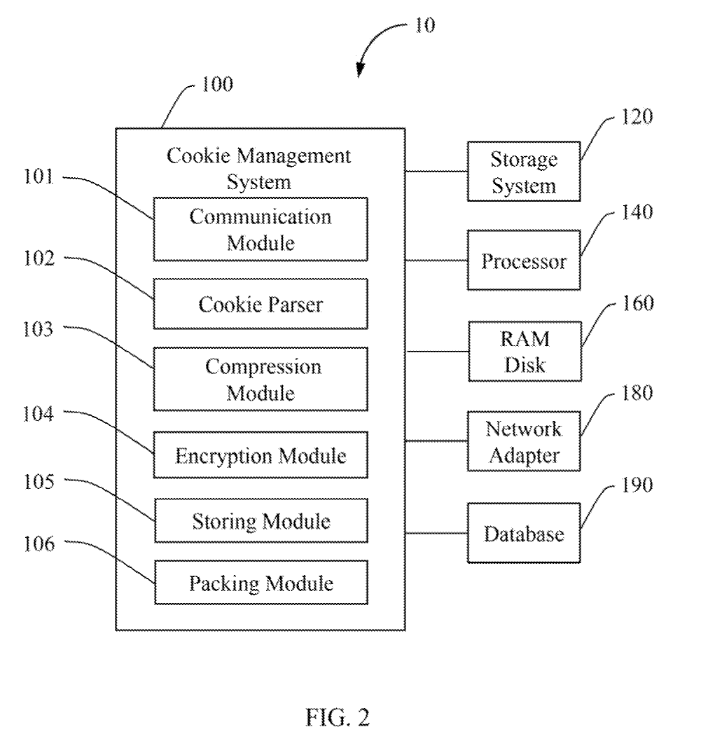

FIG. 2 is a schematic diagram of one embodiment of the function modules of the cookie management system 100. In the embodiment, the cookie management system 100 includes a communication module 101, a cookie parser 102, a compression module 103, an encryption module 104, a storing module 105 and a packing module 106. Each of the modules 101-106 may be a software program including one or more computerized instructions that are stored in the storage system 120 and executed by the processor 140.

The communication module 101 may send an HTTP request to a web server on the network, and receive a response from the web server. Both the HTTP request and the HTTP response include a header for defining the operating parameters of an HTTP transaction. The header of the HTTP request includes a host address of the web server for communication with the communication module 101. The header of the HTTP response includes a Set-Cookie segment that contains cookie data. A typical Set-Cookie segment may include a set of cookie attributes such as cookie name, cookie value, domain and expiration time. For example, a Set-Cookie segment may read “Set-Cookie:name=value; domain=.google.com;path=/;expires=Sat Oct 16 22:27:18 2011”.

The cookie parser 102 may extract the cookie data from the HTTP response.

The encryption module 104 may associate an encryption key with the cookie data and encrypt the cookie data using that key. The encryption key associated with the cookie data may be stored in the database 190. In one embodiment, the compression module 103 may compress the cookie data before encryption by the encryption module 104. In another embodiment, the compression module 103 may compress the encrypted cookie data after the encryption module 104 has encrypted the cookie data.

The storing module 105 may store the encrypted cookie data as a cookie in a memory area associated with the client device 10. In one embodiment, the memory area is part of the RAM disk 160. The content in the RAM disk 160 will be lost every time when the client device 10 shuts down, so the cookies stored in the RAM disk 160 will accordingly be lost. It can prevent the cookies from being filched by an unauthorized agency.

The packing module 106 may obtain a plurality of cookies from the memory area, pack the plurality of cookies into a single composite file, and store the single file in non-volatile storage associated with the client device 10. In one embodiment, the packing module 106 may encrypt the single composite file before storing the single file in non-volatile storage. In another embodiment, the packing module 106 may determine whether any of the plurality of cookies has expired before packing the plurality of cookies into a single file. In response to determining the expiry or otherwise of a cookie, the packing module 106 may at any time delete the cookie from the plurality of cookies.

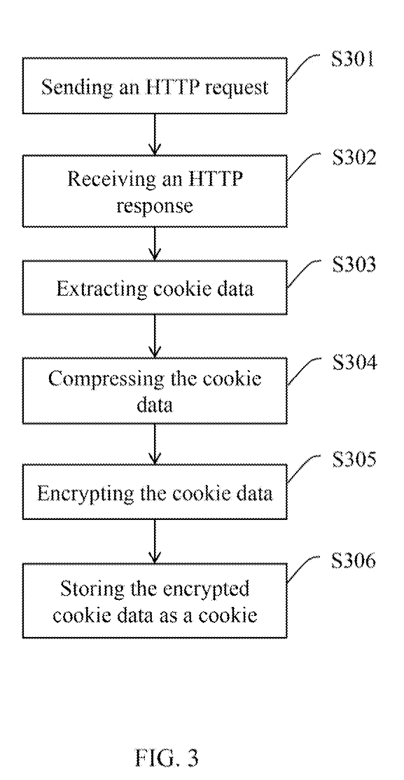

FIG. 3 is a flowchart illustrating one embodiment of a method for receiving cookies from a web server using the cookie management system of FIG. 1. The method may include the following steps.

In step S301, the communication module 101 sends an HTTP request to a web server on the network.

In step S302, the communication module 101 receives an HTTP response from the web server.

In step S303, the cookie parser 102 extracts cookie data from the HTTP response.

In step S304, the compression module 103 compresses the cookie data.

In step S305, the encryption module 104 associates an encryption key with the compressed cookie data, and encrypts the compressed cookie data using that encryption key. In another embodiment, the step S305 can be performed prior to the step S304. The encryption module 104 associates an encryption key with the cookie data and encrypts the cookie data using the encryption key, and then the compression module 103 compresses the encrypted cookie data.

In step S306, the storing module 105 stores the encrypted, compressed cookie data as a cookie in a memory area associated with the client device 10. In one embodiment, the memory area is part of the RAM disk 160.

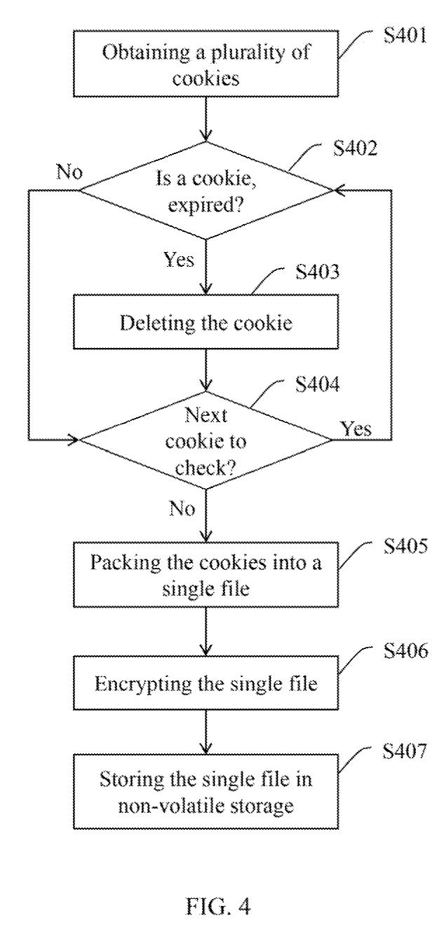

FIG. 4 is a flowchart illustrating one embodiment of a method of packing cookies using the cookie management system of FIG. 1. The method may include the following steps.

In step S401, the packing module 106 obtains a plurality of existing cookies from the memory area.

In step S402, the packing module 106 determines whether or not any of the plurality of cookies has expired before packing the plurality of cookies into a single file. If a cookie has expired, the flow goes to step S403, if not the flow goes to step S404.

In step S403, the packing module 106 deletes the cookie from the plurality of cookies and then proceeds to step S404.

In step S404, if there is a cookie that has not been checked for expiration, the flow goes to step S402. If every one of the plurality of cookies has already been checked, the flow goes to step S405.

In step S405, the packing module 106 packs the plurality of cookies into a single composite file.

In step S406, the packing module 106 encrypts the single file.

In step S407, the packing module 106 stores the encrypted single file in non-volatile storage associated with the client device 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn for or from a method may include some indication in reference to certain steps. However, the indication used is only to be viewed for identification purposes and not as a suggestion as to any order of the steps.

What is claimed is:

1. A computer-implemented method for managing cookies in a client device on a network, comprising:
sending an HTTP request to a web server on the network;
receiving an HTTP response from the web server;
extracting cookie data from the HTTP response;
associating an encryption key with the cookie data, the encryption key being stored in a database of the client device;
encrypting the cookie data using the encryption key to obtain encrypted cookie data; and
storing the encrypted cookie data as a cookie in a memory area associated with the client device.

2. The method of claim 1, wherein the HTTP request includes a host address of the web server in header of the HTTP request.

3. The method of claim 1, wherein the HTTP response includes a Set-Cookie segment comprising the cookie data in header of the HTTP response.

4. The method of claim 1, further comprising compressing the cookie data prior to encrypting the cookie data.

5. The method of claim 1, further comprising compressing the encrypted cookie data prior to storing the cookie data.

6. The method of claim 1, wherein the memory area is part of a RAM disk of the client device.

7. The method of claim 6, further comprising:
obtaining a plurality of cookies from the memory area; and
packing the plurality of cookies into a single file.

8. The method of claim 7, further comprising storing the single file in non-volatile storage associated with the client device.

9. The method of claim 8, further comprising encrypting the single file prior to storing the single file.

10. The method of claim 7, further comprising:
determining whether each of the plurality of cookies has expired prior to compressing the plurality of cookies into the single file; and
when a cookie of the plurality of cookies has expired, deleting the cookie from the plurality of cookies.

11. A system for managing cookies in a client device on a network, comprising:
a communication module adapted to send an HTTP request to a web server on the network and receive an HTTP response from the web server;
a cookie parser adapted to extract cookie data from the HTTP response;
an encryption module adapted to associate an encryption key with the cookie data and encrypt the cookie data using the encryption key to obtain encrypted cookie data; and
a storing module adapted to store the encrypted cookie data as a cookie in a memory area associated with the client device.

12. The system of claim 11, wherein the HTTP request includes a host address of the web server in header of the HTTP request.

13. The system of claim 11, wherein the HTTP response includes a Set-Cookie segment comprising the cookie data in header of the HTTP response.

14. The system of claim 11, further comprising a compression module adapted to compress the cookie data.

15. The system of claim 11, further comprising a compression module adapted to compress the encrypted cookie data.

16. The system of claim 11, wherein the memory area is part of a RAM disk of the client device.

17. The system of claim 16, further comprising a packing module adapted to obtain a Page 11 of 13 plurality of cookies from the memory area and pack the plurality of cookies into a single file.

18. The system of claim 17, wherein the packing module is further adapted to store the single file in non-volatile storage associated with the client device.

19. The system of claim 18, wherein the packing module is further adapted to encrypt the single file.

20. The system of claim 17, wherein the packing module is further adapted to determine whether each of the plurality of cookies has expired, and in response to determining a cookie of the plurality of cookies has expired, delete the cookie from the plurality of cookies.
